(19) United States
(12) Patent Application Publication
(10) Pub. No.: US 2008/0109304 A1
(43) Pub. Date: May 8, 2008

(54) Method and system for personalized promotional advertising via registered card technology

(76) Inventors: Seth H. Sarelson, New York, NY (US); Jonathan A. Treiber, New York, NY (US)

Correspondence Address: HEDMAN & COSTIGAN P.C., 1185 AVENUE OF THE AMERICAS, NEW YORK, NY, 10036, US

(21) Appl. No.: 11/800,120

(22) Filed: May 4, 2007

Related U.S. Application Data
(60) Provisional application No. 60/856,631, filed on Nov. 3, 2006.

(51) Int. Cl. G06Q 30/00; G06Q 90/00

(52) U.S. Cl. 705/14

(57) ABSTRACT

An internet-based process through which merchants can execute targeted marketing campaigns to individuals based on payments data in addition to traditional criteria such as tastes, preferences and demographics. The process utilizes registration of bankcard association branded credit and debit cards as well as other payment vehicles for a consumer rewards program that tracks payment data at merchants that are registered for the service. The merchant has the ability to advertise to an infinite number of individuals with no up-front marketing costs, paying only a marketing fee that is a percentage of a transaction between a registered cardholder or payment vehicle holder and that merchant. Unlike traditional advertising, the invention allows merchants to discriminately offer different incentives (discounts or other incentives) to different consumers in a discrete fashion.

The process helps entities that sell advertising (such as media companies) quantify the effectiveness of this advertising to merchants by tracking every time a registered consumer makes a purchase with the merchant. Additionally, the process helps both advertising and fundraising entities, such as non-profits, capture a percentage of the spending between registered cardholders or payment vehicle holders and merchants.

### CROSS REFERENCE TO RELATED APPLICATIONS

This application claims priority from U.S. Provisional Application 60/856,631, filed on Nov. 3, 2006.

### FIELD OF THE INVENTION

The invention relates to the field of advertising and rewards programs. More particularly, the invention relates to advertising and rewards programs that allow merchants to target consumers based on various criteria.

### BACKGROUND OF THE INVENTION

Traditional credit and debit card rewards programs have been limited to one card and are funded by the issuing-bank using a portion of interchange revenues (merchant transaction fees deducted from each payment). Because consumer interchange rates are less than 2% of a transaction, most rewards programs are not all that economically advantageous to the consumer and are simply a way to promote the credit/debit card as an alternative to other payment methods for a given purchase.

For example, US Pub. 2004/0199422 to Napier et al. discloses a consumer transaction-based marketing of goods and services. This publication teaches a method whereby, when a registered credit/debit card is used to make a purchase at a registered merchant, the merchant pays a fee to the marketer who registered both the card user and the merchant. However, this method fails to teach a method to allow merchants to specifically target certain consumers, and it fails to teach a method to allow consumers to specifically request types of merchants.

Many of the larger issuing banks have realized that in order to deliver incremental value to each cardholder, merchant alliances are necessary. In the case of various popular rewards programs, the issuing bank creates a currency that consumers accrue with each additional purchase. To drive incremental sales to a given merchant, the bank will sell proprietary currency to large merchants; the proprietary currency is then allocated back to the consumer after a purchase is made from the merchant. Banks have realized that rewards programs need merchant funding to deliver real value to each cardholder, but this requires significant up-front cost to the merchant and in no way allows the merchant to engage in promotional advertising activities outside of the offering of incremental bank currency to the issuer's cardholders. Furthermore, these programs are of value only to the largest merchants and exclude the vast majority of the merchant universe.

Registered card loyalty processors realize that they can deliver significant value to consumers and others by administering programs whereby consumers can register any existing credit or debit card for a richer rewards program that is funded by a third party, such as a merchant or loyalty club. The registered card loyalty processors leverage the payments system to track these payments between registered consumers and merchants to administer a variety of loyalty programs for third parties.

These third parties include entities such as U-Promise® and Rewards Network^{SM}. These parties offer a variety of cash-back and points-based rewards to registered cardholders at a variety of merchants. The standard set of rewards is available to each consumer member, and any enrolled merchant has exposure to all of the program's consumer members. Neither one of these programs offers any type of targeting criteria or personalized approach to promotional advertising for each merchant.

Merchants engage in marketing efforts with substantial up-front costs. Direct mail and other traditional media are not cost-effective and erect a barrier that prevents merchants with less capital from engaging in effective marketing through traditional channels. Traditional marketing efforts have burdened merchants with up-front costs regardless of the successes of such efforts. A merchant must pay for a television advertisement, direct mail campaign, or a newspaper advertisement even if no revenue is generated. When revenue is generated, the merchant can only guess at the effectiveness of each advertising method unless some type of tracking method (e.g., promotional codes or coupons) is used. The up-front costs and lack of transparency are a major frustration to the merchant's ad buyer(s).

Innovative companies such as Google® have been able to eliminate the up-front costs of advertising and move to a pay-per-click advertising model for merchants with an internet presence via its AdWords(g service, but have been burdened by a phenomenon known as click-fraud, whereby one merchant uses malicious computer programs to click on a competitor's ad without making any purchases, thereby draining that competitor's ad budget. Google® does not currently offer pay-per-sale promotional advertising to its merchants.

Many brick-and-mortar merchants also suffer from the inability to segment consumers based on transactional history between a given merchant and its consumer base. Larger merchants who may offer their own branded credit cards can do this to an extent, but even they do not have the insight necessary to segment consumer marketing based on spending on other cards. The vast majority of merchants have no effective means to segment based on transactional data or to use this information to discriminately offer different promotions to different consumers in a discrete fashion.

Consumers are more distracted than ever, receiving content via an increasing number of non-traditional media. Consumers are also more empowered, with nearly perfect information on each merchant's pricing, service, and customer experiences readily available on the Internet. As TiVo® has shown, consumers will actively choose to ignore or skip advertisements if given the choice. The conclusion is that consumers demand the most relevant information--when they want it, how they want it. Much of today's effective marketing utilizes opt-in “permission” from each consumer to contact that consumer with relevant information at a preferred time and by a particular method specified by the consumer.

Media companies (defined in this document as any content provider who sells advertising or seeks to sell advertising in the forms of, for example, mail, email, text messaging, interactive voice response, magazine, newspaper, television, radio, web portal, blog, search engine, internet website, video games, podcasts and other media formats) struggle with the inability to quantify the effectiveness of advertising sold to a given merchant. The merchant can use circulation counts and third party data like the Nielsen Media Research® ratings to evaluate the reach of marketing, but this ultimately has little transparency, and there are very few options for determining the effectiveness of this advertising. If a media company could prove the worth of the advertising sold by tracking the revenue generated from its consumer base to advertising merchants, the media company could potentially charge higher advertising rates or introduce a performance-based sales model.

Not-for-profits struggle with the inability to fundraise on a recurring basis without having to plan and execute targeted fundraising activities. Considering that these activities are often at a large cost to the organization, not-for-profits would significantly benefit from a reduction in operating expenses and the introduction of fundraising that sustains itself with little or no additional effort from the organization.

For these reasons, it is desirable to provide a targeted marketing system that utilizes the payments system for a registered payment vehicle loyalty program focused on personalized promotional advertising from merchants to consumers who may or may not be affiliated with a variety of loyalty partners.

### SUMMARY OF THE INVENTION

It is therefore an object of the present invention to provide an advertising and rewards program that allows for a merchant to specifically target a class of consumers, for example, specific groups of individuals, organizations, or businesses for efficient advertising purposes.

It is another object of the present invention to provide an advertising and rewards program that allows for a consumer to specify interests, demographic info, etc. in order to allow a merchant to specifically target that consumer.

It is a further object of the present invention to provide for a simple method of fundraising for not-for-profit organizations and other companies.

It is an even further object of the present invention to provide a method whereby merchants and/or media providers can track the effectiveness of their advertising campaigns.

It is a further object of the present invention to provide a method whereby consumers can accumulate rewards in the form of money, discounts, or other known rewards forms.

It is yet a further object of the present invention to provide a targeted marketing system that utilizes the payments system for a registered payment vehicle loyalty program focused on personalized promotional advertising from merchants to consumers who may or may not be affiliated with a variety of loyalty partners.

Accordingly, these objects and others not particularly set forth above are achieved by the method and system of the present invention which comprises the steps of registering consumers with a service, causing the consumers to submit information about themselves concerning shopping habits and/or preferences, registering merchants with the service, causing the merchants to submit information about their goods and services, and matching merchants and consumers.

The flow of funds preferably addresses a solution to the fact that not-for-profits and other organizations (beneficiary organizations) struggle with the inability to fundraise on a recurring basis without having to plan and execute targeted fundraising activities. These activities are often at a large cost to the organization. These organizations stand to significantly benefit from a reduction in operating expenses and the introduction of fundraising that sustains itself with little additional effort from the organization.

The invention of the present application can therefore be a tool that helps not-for-profits and other organizations fundraise on a recurring basis by capturing a percentage of the spending between registered consumers/donors and registered merchants. Consumers can elect to make a tax-deductible donation to a not-for-profit for a percentage of each merchant's incentive. The preferred method of the present invention differs significantly from existing fundraising activities in that it allows a not-for-profit or other beneficiary organization to capture incremental donations from individuals at no cost to the donors or the organization. Because many not-for-profit organizations are limited by their ability to induce consumers to actively make payments to the organization, the present method helps these organizations fundraise on a recurring basis without requiring donors to actively make a payment, utilizing any additional resources or bombarding consumers with solicitations.

It is also envisioned that a registered consumer can create, within the account, an organization to which the reward can be donated.

The invention also preferably provides a method for targeting promotional advertising that allows merchants to utilize payments data, along with tastes and preferences, and demographic data to segment a population of consumers and discriminately offer targeted promotions in a discrete manner to as many or few consumers as desired. Consumers register any payment vehicle, for example, credit and debit cards, prepaid cards, check cards, chip cards, and gift cards; each merchant gives consent to allow usage of its payments data; and the method tracks payments between registered cardholders and merchants. Any suitable entity can register the consumer's payment vehicle, but most preferred is a marketer, an affiliate marketing network, a financial institution, a bank, an affinity organization, a payment card issuer, a merchant, a data vendor, a media company, or a third-party marketing company. The method is essentially an order-taking promotional advertising service that utilizes tracking via the payments system to eliminate the up-front costs of advertising and charge merchants a percentage of revenues generated from registered cardholders or payment vehicle holders. Merchants utilize a web-based platform to initiate one or more advertising campaigns, targeting different incentives to different groups of individuals based on a variety of criteria. Merchants also utilize the web-based platform to receive reporting that details consumer spending, consumer profiling (demographics, interests, etc.), and view applicable fees.

The preferred method of the present invention provides a significant advantage to the merchant because the service works through the payments system, empowering merchants to offer a variety of incentives without having to run the transaction any differently or even notify the cashier. Merchants can offer any type of incentive through the service. These incentives can include (but are not limited to):
Basic content (ex. “Come in at 6 PM for our big sale!” or “Free shipping on all orders over $50!”)
Percentage discounts (ex. “10% off” or “10% off when you spend $100 or more!”)
Dollar value discounts (ex. “$10 off” or “$10 off when you spend $100 or more!”)
Frequency discounts (ex. “Shop five times, get 50% off on your sixth purchase!”)
Big spender discounts (ex. “Spend over $500 this month and get $100 off your next purchase!”)

Merchants can also offer exclusive offers to communicate with and reward only a select group of consumers:
A merchant's most loyal customers (ex. Have spent over $1000 or made more than ten purchases in the last six months)
New or infrequent customers—verified by payments history (ex. Have not spent over $50 or made more than 1 purchase in the last six months)

This segmentation tool provides a more complete picture of each consumer, because the merchant can segment based on payment history across all of the payment vehicles that a consumer may register. This broader scope paints a much fuller picture of the consumer's spending and allows the merchant to focus on its existing relationship (or lack thereof) with each consumer.

Unlike traditional advertising, merchants can limit exposure for each campaign and execute quickly to move inventory and alert consumers of a special event.

In another aspect, the preferred method of the present invention is directed to a personalized payment vehicle rewards program that creates a completely unique pool of incentives for each individual based off of payments data, along with tastes and preferences, and demographic data. This completely free program provides additional rewards on any payment vehicle, regardless of issuing bank or bankcard association. The consumer can register multiple payment vehicles and aggregate rewards. This is a significant advantage in the case that a credit card is used for business expenses, because the cardholder can receive cash-back rewards from purchases that are reimbursed or paid for by the business.

From the consumer's perspective, the rewards are likely to be much richer because (1) they are merchant-funded and (2) the merchant has chosen to target the individual to motivate spending based on a variety of criteria.

A summary of the preferred steps of the present invention is as follows:
The consumer utilizes a web-based platform to register any payment vehicle(s). The registration preferably includes inputting demographic information and interests, specifying preferred method and time of contact, and optionally choosing to automatically donate a portion of rewards to any organization for which they have an affinity (beneficiary organization).
2. The consumer then receives a targeted communication detailing his or her personalized incentives.
3. The consumer then makes a purchase with the registered payment vehicle(s).
4. The consumer preferably receives a targeted thank-you communication for shopping with the merchant that quantifies his or her savings, if applicable.
5. At the end of a given period, e.g., the end of the month, the consumer receives a credit on his or her payment vehicle statement for the total value of all discounts redeemed.
6. At the end of each time period, the consumer preferably receives an email with a breakdown of his or her savings and donations with a thank-you message on behalf of any selected beneficiary organization.

In another preferred aspect, the invention is a tool that helps media companies quantify the effectiveness of their advertising to merchants. In this aspect of the invention, the media company offers a branded rewards program to its consumer base with incentives from merchants who currently advertise with the media company.

By tracking the spending between registered consumers of the media company and registered advertising merchants, the revenue contribution that the media company's consumer base drives to the advertiser is quantified. For the merchant's ad buyer, this is a crucial metric that will influence future advertising spending. For the media company, this is a crucial metric that can lead to the ability to raise advertising rates or even potentially change the media company's ad sales revenue model to be performance driven as opposed to charging significant up-front costs regardless of performance.

In yet another preferred aspect, the preferred invention is a tool that helps not-for-profits or other beneficiary organizations fundraise on a recurring basis by capturing a percentage of the spending between registered consumers/donors and registered merchants. Consumers can elect to make a tax-deductible donation to the not-for-profit for a percentage of each merchant's incentive. The invention differs significantly from existing fundraising activities in that it allows a not-for-profit or other beneficiary organization to capture incremental donations from individuals at no cost to the donors or the organization. Because many organizations are limited in their ability and success with getting consumers to actively make payments to the organization, the invention helps these organizations fundraise on a recurring basis without utilizing any additional resources or bombarding consumers with solicitations.

The preferred method includes a promotional advertising service that operates via the payments system and creates a new type of advertising that empowers merchants of all sizes with the ability to segment based on payments data across all of a consumer's registered payment vehicles and eliminates the up-front costs of advertising, with each merchant only paying a marketing fee when revenues are realized.

The method of the present invention differs from other registered card loyalty programs in that it offers merchants the ability to utilize an order-taking service to segment a population of consumers and discretely offer different discounts/incentives to individuals based on a variety of criteria previously mentioned. This segmentation allows each merchant to offer richer incentives to individuals because it is a promotional advertising service that addresses that each consumer is unique and needs to be motivated differently. Furthermore, the ability to limit exposure to as many consumers as each merchant desires, provides each given merchant with the ability to budget effectively.

The preferred method differs from other registered payment vehicle loyalty programs in that it offers consumers a completely personalized rewards program that utilizes consumer-provided information to deliver the most relevant incentives at a preferred time and via a method specified by each consumer. Traditional rewards programs offer the same incentives to every individual and require the consumer to search lists of incentives at participating merchants to identify those that are relevant. This method differs from today's programs in that it sources and delivers the most relevant incentives to each individual, in the most convenient manner and at the most convenient time. Additionally, the present method eliminates the need for consumers to obtain any additional loyalty tracking devices/cards (ex. supermarket loyalty cards with no credit facility), promotional codes, or coupons.

In accordance with the principles of the preferred method of this invention, the merchant does not have to take any proactive steps to participate aside from utilizing the web-based platform to sign up and initiate campaigns. There is no training of cashiers or purchase of additional software or hardware required. If the merchant can accept the various payment vehicles, they can utilize this invention.

The principles of the preferred method of the present invention are effective for promoting the goods and services of both brick & mortar and internet-based merchants. Up-front funds that each merchant otherwise would have spent on direct-mail, mass-media advertising, or other methods directed at customer acquisition and retention can be eliminated, resulting in a much more economical model that ties advertising costs to actual merchant revenues. The invention preferably eliminates the financial risks associated with traditional advertising and provides a clear advantage with a new type of customer segmentation tool available to merchants of every size.

### BRIEF DESCRIPTION OF THE DRAWINGS

The attached drawings are intended to better illustrate the present invention without limiting it in any manner whatsoever.

FIG. 1 is a schematic diagram illustrating one preferred embodiment of parties interacting in accordance with the principles of this invention.

FIG. 2 is a schematic diagram illustrating one preferred embodiment of the flow of funds involved in the media company as a loyalty partner aspect of this invention.

FIG. 3 is a schematic diagram illustrating one preferred embodiment of the flow of funds involved in the not-for-profit as a loyalty partner or consumer-facing donation aspect of this invention.

FIG. 4 is a schematic diagram illustrating one preferred embodiment of the ability to quantify the effectiveness of a loyalty partner's advertising with the media company as a loyalty partner.

### DETAILED DESCRIPTION OF THE PRESENT INVENTION

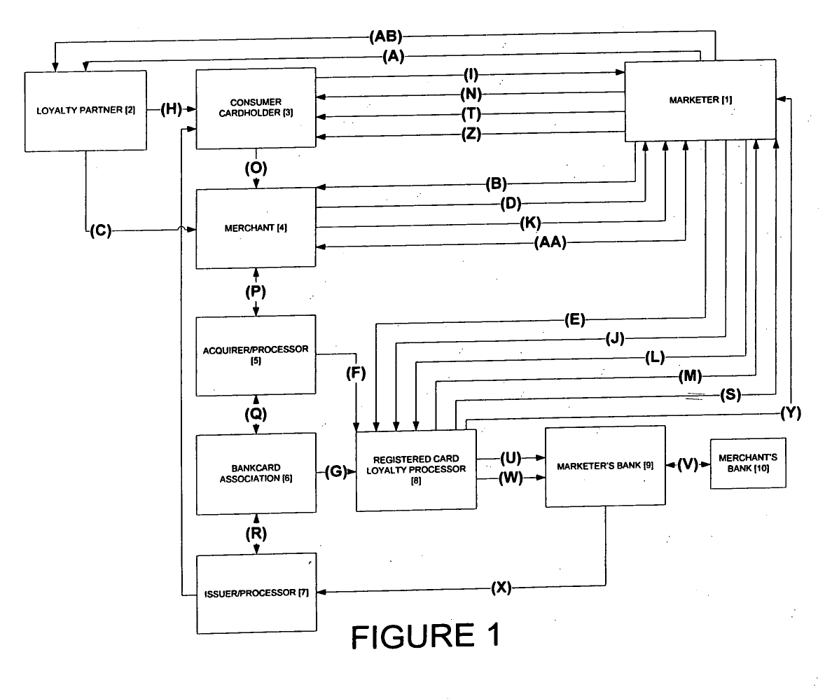

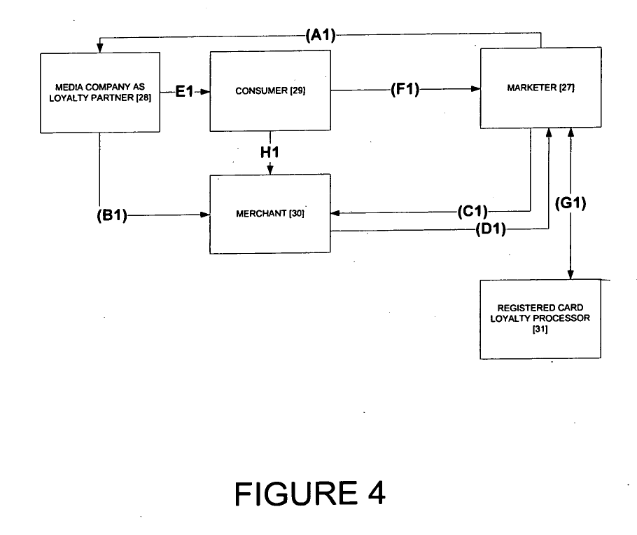

The following description of preferred embodiments is presented to describe the present invention and is not to be construed to limit the scope of the appended claims in any manner whatsoever. In FIGS. 1 and 4, for the sake of clarity, letters are used to designate steps and numbers are used to designate entities.

As best shown in FIG. 1, a marketer (1) approaches (A) potential loyalty partners (2), which can include media companies and not-for-profits as well as other affinity groups. A given loyalty partner (2) agrees to offer the marketer's reward program under their own brand. The marketer (1) and/or the loyalty partner (2) determine the most relevant merchants (4) for the consumer base (3). The marketer (1) and/or the loyalty partner (2) execute an independent or joint sales effort to sign up these merchants (4) (B, C). This joint sales effort (B, C) applies to one aspect of this invention pertaining to media companies and not-for-profits with advertising relationships, where the marketer (1) leverages these relationships to execute the joint sales effort (B, C). A significant advantage of the invention is the ability to strengthen these advertising relationships by quantifying the revenue contribution from the loyalty partner's (2) registered consumer base (3) to the registered merchant (4).

Each merchant (4) is directed (D) to the marketer's (1) website. The merchant uses the website to provide basic contact information, a business description, merchant identification numbers, acquiring institution information, processor information, and other information necessary to obtain the merchant's (4) transactional information. The merchant (4) gives consent to the marketer (1) for the registered card loyalty processor (8) to legally obtain the merchant's (4) transactional information from the marketer (1) (E). The merchant (4) selects reporting services that can be purchased from the marketer (1) and agrees to the given marketing fees. The merchant (4) then provides the ABA (American Banker's Association) routing number and bank account number necessary to initiate ACH (Automated Clearing House) debits and agrees to allow the marketer (1) to initiate ACH debits for billing purposes. The necessary merchant (4) information is forwarded from the marketer (1) to the registered card loyalty processor (8) (E). As soon as the registered card loyalty processor (8) has the merchant's (4) consent and is instructed to do so by the marketer (1), the registered card loyalty processor (8) will begin tracking payments information (the on-boarding process) from the merchant's acquirer or POS Processor (5) or the bankcard association (6) as necessary (F, G).

After a sufficient number of merchants (4) have been signed up for the program, the loyalty partner (2) then contacts (H) their consumer base (3) to sign up individuals for the program. The consumers logon to a white-labeled website supported by the marketer (1) (I). At this point, consumers (3) can register any existing credit and debit cards, regardless of issuer or bankcard association. Additionally, each consumer (3) provides information on tastes and preferences, demographics, and preferred contact methods/times to the marketer (1). The marketer (1) then passes this information back to the registered card loyalty processor (8) (J).

Once a merchant (4) has been signed-up by the registered card loyalty processor (8), the merchant (4) can go back to the marketer's (1) webpage (K) and use a campaign manager provided by the marketer (1) to initiate targeted promotional advertising campaigns to individuals (3) based on payments history at that particular merchant (4) across all credit and debit cards, tastes and preferences, and demographic information.

This is a significant advantage of the invention in that a merchant (4) of any size can utilize this order-taking promotional advertising service to discretely segment the population for a promotional offering and limit exposure to a desired number of individuals. The principles of the invention are effective for promoting the goods and services of both brick & mortar and internet-based merchants. Up-front funds that each merchant otherwise would have spent on direct-mail, mass-media advertising, or other methods directed at customer acquisition and retention can be reduced or eliminated, resulting in a much more economical model that ties advertising costs to actual merchant revenues. The invention eliminates the financial risks associated with traditional advertising and provides a clear advantage with a new type of customer segmentation tool available to merchants of every size. Furthermore, the ability to discretely communicate with each individual affords the merchant the ability to discriminately offer discounts to some and not to others in an effort to maximize customer acquisition and retention without decreasing margins. This type of activity is not possible via traditional media and will likely result in richer discounts for targeted consumers.

After the merchant (4) has utilized the campaign manger to initiate targeted promotional advertising campaigns (K), the marketer (1) works with the registered card loyalty processor (8) (L) to update a database of registered cardholders (3) and combine segmentation criteria from merchants (4) (K) with consumer preferences (I). The registered card loyalty processor (8) then sends a file to the marketer (1) with available incentives for each consumer (3) (M). This process enables the marketer (1) to deliver a completely personalized communication with a completely personalized set of incentives (discounts and promotional text) to each individual consumer (3) (N).

Once the consumer (3) has received a list of personalized incentives, the consumer (3) shops with a merchant (4) enrolled in the program (0). The cashier and other consumers are unaware of the discount and the consumer pays full price at the point-of-sale (0). The transaction is processed as normal between the merchant (4), acquirer/processor (5), bankcard association (6), and issuer/processor (7) (P, Q, R).

A significant benefit of the invention is that the consumer provides personal information up-front to the marketer in return for the periodic delivery of a list of personalized incentives that is delivered at the desired time and via the desired means specified by the cardholder. This invention differs significantly from other registered card loyalty programs in this manner because it does not require the consumer to proactively search lists of incentives at participating merchants to determine relevance and then make a purchase. Because each consumer can receive a completely unique list of incentives that are targeted to that individual based on a variety of factors previously mentioned, the invention has a significant advantage over any registered card loyalty programs that exist in the marketplace.

Another significant benefit of the invention is the elimination of the consumer's need and social anxiety associated with carrying coupons, remembering promotional codes, or utilizing any type of merchant loyalty card to track purchases. Because the discount is applied after the point of sale, the merchant also avoids the difficult task of training cashiers to change the checkout process in the case of a brick-and-mortar merchant or purchasing additional software/hardware.

After the transaction has been processed as normal, the registered card loyalty processor (8) receives payment information from the merchant's acquirer or POS Processor (5) or the bankcard association (6) (F, G). The registered card loyalty processor (8) then matches this information against a database of registered cardholders (3) supplied by the marketer (1) (L). If the transaction qualifies, meaning that that merchant's (4) discount was allocated to that individual cardholder (3), it is aggregated into a file with other qualified transactions provided (S) by the registered card loyalty processor (8) to the marketer (1). The marketer (1) then generates a personalized thank-you communication (T) to each consumer (3) on behalf of the participating merchant (4) where the qualifying transaction took place.

At the end of each week, the registered card loyalty processor (8) generates an ACH debit file based on each merchant's (4) outstanding rewards and fees due to consumers (3) and the marketer (1). The file is delivered to the marketer's bank (9) (U). The marketer's bank (9) then initiates ACH debits (V) to each merchant's bank account (10) for the amount due.

At the end of each month, the registered card loyalty processor (8) generates an credit file based on each cardholder's (3) accumulated rewards. The file is then delivered to the marketer's bank (9) (W). The marketer's bank (9) then initiates a credit to each consumer credit or debit account at the issuing bank (7) (X).

An individual consumer (3) may choose to register multiple credit/debit cards (or other payment vehicles) and aggregate rewards on one card. This is a significant advantage in the case that one of the cards is used for business expenses, because the cardholder (3) can receive rewards from purchases that are reimbursed or paid for by that cardholder's (3) employer.

At the end of each month, the registered card loyalty processor (8) generates detailed reporting for each cardholder (3), merchant (4), and loyalty partner (2) (Y) that is then delivered by the marketer (1) to the cardholder (3) (Z), the merchant (4) (AA), and the loyalty partner (2) (AB).

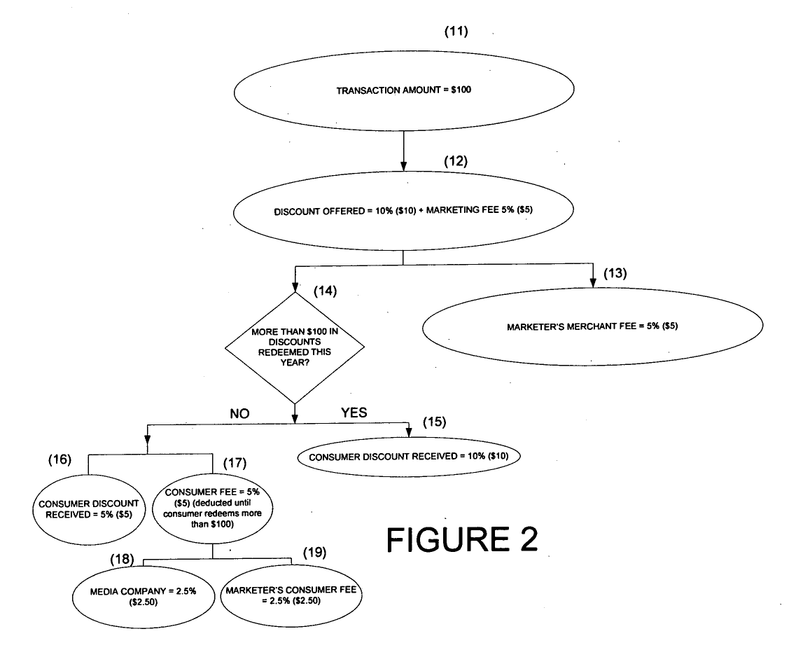

As best shown in FIG. 2, a given transaction (11) is initiated between a registered cardholder and merchant with an outstanding offer to the cardholder. For the purpose of the example, the transaction amount is $100. The marketer collects (12) the value of the discount offered plus a marketing fee. For purpose of the example, the discount offered is 10% ($10) and the marketing fee is 5% ($5). In general, the value of the discount is set by the merchant. The marketer retains (13) a merchant fee of, in FIG. 2, 5% ($5). The consumer's discount is subject to a decision point (14). If the consumer has redeemed more than a pre-determined amount ($100 for the purposes of this example) in discounts in a given year, then the consumer retains the full discount offered (15). If the consumer has not redeemed more than the predetermined amount ($100 for the purposes of this example) in discounts in a given year, then the consumer receives (16) a percentage of the entire discount, and the marketer also receives (17) a percentage of the entire discount as a fee. The marketer's fee can then be shared at a negotiated split between the media company (18) and the marketer (19).

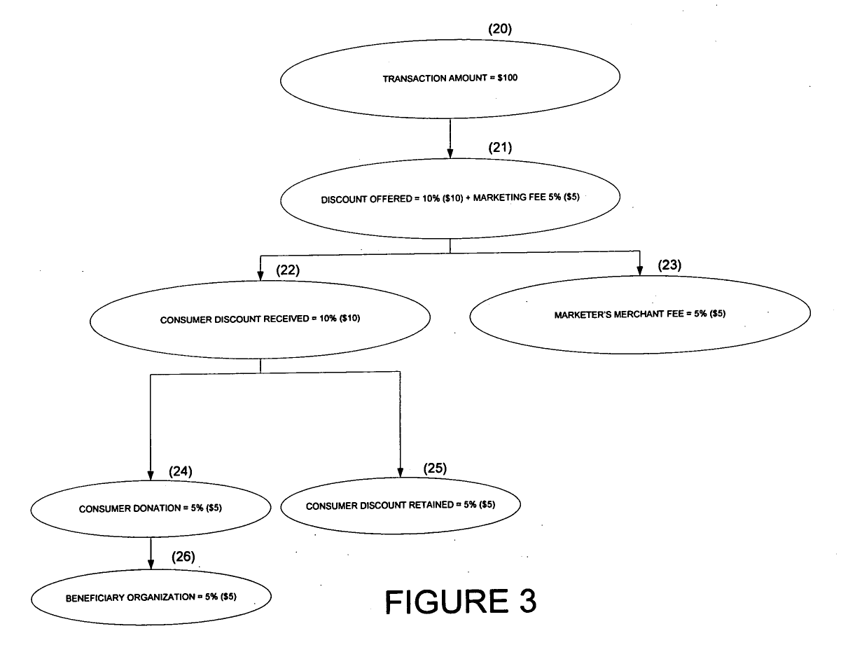

As best shown in FIG. 3, the invention can be used by a not-for-profit group or as a consumer-designated beneficiary donation method. The not-for-profit may have a formal relationship with the marketer or the consumer may designate a beneficiary organization (not-for-profit or other) to receive funds. More specifically, a given transaction is initiated (20) between a registered cardholder and merchant with an outstanding offer to the cardholder. For the purpose of the example, the transaction amount is $100. The marketer collects (21) the value of the discount offered plus a marketing fee. For purposes of the example, the discount offered is 10% ($10) and the marketing fee (23) is 5% ($5). In general, the merchant determines the value of the discount. A traditional rewards program would terminate when the consumer receives the 10% ($10) discount (22). However, in this embodiment of the invention, the consumer can donate (24) a percentage of the discount to a beneficiary organization (26). The consumer can elect to donate 100% of the discount (24) to the beneficiary organization (26). However, the consumer can also elect to donate less than 100% of the discount (24) to the beneficiary organization (26), and the consumer will keep the remaining percentage (25).

The invention motivates the consumer to make a purchase (20) and then introduces a “feel good” component whereby the beneficiary organization (26) can recognize a significant donation every time a registered cardholder makes a purchase from a registered merchant with an outstanding offer (21) to the cardholder. This invention provides a significant advantage over traditional fundraising activities because it is transaction-based and does not require the donor to actually make a payment to the beneficiary organization.

FIG. 4 is a preferred embodiment of the ability to quantify the effectiveness of a loyalty partner's (28) advertising.

The marketer (27) approaches potential loyalty partners (28) (Al). With the introduction of the marketer (27) working with the media company as a loyalty partner (28), the traditional relationships begin to change in the following ways:

When the media company (28) sells advertising to a merchant (30), the media company (28) promotes enrollment (B1) in a registered card rewards program. The marketer (27) can also sell directly to the merchant (30) (C1). This may or may not be a co-branded effort with the media company (28). Merchants (30) then register with the marketer (27) (D1).

When the media company (28) provides content to the consumer (29), the media company (28) promotes (E1) enrollment in a registered card rewards program. Consumers (29) register with the marketer (27) (F1).

When both the consumer cardholders (29) and merchants (30) register with the marketer (27), the invention utilizes (G1) the registered card loyalty processor (31) via the process as illustrated in FIG. 1. When the consumer (29) makes a purchase with the merchant (30) (H1), the invention eliminates the uncertainty of the revenue contribution driven by the merchant's (30) advertising with the media company (28).

Because the preferred method can track the spending between registered consumer cardholders (29) and registered merchants (30) (Hi), both the media company (28) and the merchant (30) know exactly how much spending took place (Hi) between the media company's registered consumer cardholders (29) and the given merchant (30).

The method of the present invention is a significant improvement upon the existing relationship between a media company and merchants who purchase advertising because it allows both parties to quantify the revenue contribution from registered cardholders and other payment vehicle holders who receive content from the media company and the registered merchant. For the merchant's ad buyer, this is a crucial metric that will influence future advertising spending. For the media company, this is a crucial metric that can lead to the ability to raise advertising rates or even potentially change the media company's ad sales revenue model to be performance driven as opposed to significant up-front costs regardless of performance.

Variations, modifications and changes to the preferred method described above will be apparent to those skilled in the art. All such variations, modifications and changes are intended to fall within the spirit and scope of the present invention, limited solely by the appended claims.

1. A method of marketing goods and services of a merchant comprising the steps of:
a. registering a participating merchant's identification number;
b. creating a consumer account associated with a registered consumer, said account including one or more registered payment vehicles;
c. creating a personalized profile for said registered consumer based on a transactional history and/or other data sources related to the registered consumer;
d. delivering advertisements to said registered consumer;
e. accepting said registered payment vehicles for the purchase of goods and/or services at a participating merchant;
f. scanning transactional data to match transactions from a participating merchant with a registered payment vehicle;
g. charging a participating merchant a marketing fee when said advertising has directly resulted in a sale of goods and/or services to said registered consumer;
h. crediting a reward to said consumer account associated with said registered consumer.

2. The method of claim 1, wherein said payment vehicle is one or more selected from the group consisting of a credit card, debit card, prepaid card, check card, chip card, and gift card.

3. The method of claim 1, wherein the step of registering a payment vehicle of said registered consumer is performed by one or more entities selected from the group consisting of a marketer, an affiliate marketing network, a financial institution, a bank, an affinity organization, a payment card issuer, a merchant and a media company.

4. The method of claim 1, wherein said registered consumer is taken from the group consisting of either an individual, an organization or a business.

5. The method of claim 1, wherein the step of delivering advertisements to said registered consumer is taken from the group consisting of mail, email, text messaging, interactive voice response, magazine, newspaper, television, radio, web portal, blog, search engine, internet website, video games, podcasts and other media formats.

6. The method of claim 1, wherein a percentage of said reward is automatically donated to an organization.

7. The method of claim 6, wherein said organization is created by said registered consumer within said consumer account.

8. The method of claim 1 wherein said reward is in the form of a cash-back reward.

9. The method of claim 6 wherein said organization is a non-profit organization.

10. The method of claim 1, wherein said personalized profile is created from data collected by one or more entities selected from the group consisting of a marketer, an affiliate marketing network, a financial institution, a bank, an affinity organization, a payment card issuer, a merchant, a media company, a data vendor, and a third-party marketing company.

11. The method of claim 1, further comprising the steps of collecting transactional history for a registered consumer and using said transactional history to gauge said registered consumer's tastes and preferences.

12. The method of claim 1, further comprising the step of creating different advertisements of basic content, percentage discounts, dollar value discounts, and frequency discounts to target consumers based on transactional history, demographic data, and/or tastes and preferences of said consumers.

13. The method of claim 12, wherein the step of creating different advertisements is performed with direct involvement from one or more of a marketer, an affiliate marketing network, a financial institution, a bank, an affinity organization, a payment card issuer, a merchant, a media company, and a data vendor.

14. The method of claim 1, further comprising the step of determining if a particular advertisement is to be delivered to a registered consumer based on one or more of the payment vehicles in the consumer account.

15. The method of claim 3, wherein said entity is a media company that provides media content to consumers.

16. The method of claim 1, further comprising the step of studying response rates to said advertising in order to quantify the effectiveness of said advertising.

17. The method of claim 1 wherein said reward is in the form of a points or currency based reward.

18. The method of claim 15 wherein said media content is in the form of one or more of magazines, newspapers, television networks, radio stations, web portals, blogs, search engines, internet websites, and video games.
